(19) United States
(12) Patent Application Publication
(10) Pub. No.: US 2020/0175361 A1
(43) Pub. Date: Jun. 4, 2020

(54) PARTITIONING OF DEEP LEARNING INFERENCE WITH DYNAMIC OFFLOADING

(71) Applicant: Alibaba Group Holding Limited, Grand Cayman (KY)

(72) Inventors: Shuai Che, Sunnyvale, CA (US); Guoyang Chen, Sunnyvale, CA (US); Yingmin Li, Cupertino, CA (US)

(21) Appl. No.: 16/206,082

(22) Filed: Nov. 30, 2018

(51) Int. Cl. G06N 3/08; G06N 5/04

(52) U.S. Cl. CPC G06N 3/08; G06N 5/04

(57) ABSTRACT

Systems and methods are provided for improving the learning inference performance by partitioning the learning inference based on system fluctuations and available resources by parsing a trained neural network model of a neural network into a data flow graph with a plurality of nodes; generating a traversal order of the data flow graph; assigning a load level range to each edge device, an interconnect connecting the edge device and a cloud computing platform, and the cloud computing platform; profiling performance of each node over the load level range for the edge device and the cloud computing platform; and determining a partition point of the data flow graph based on the profiled performance of each node. By using a lookup table storing the profiled performance, the data flow diagram may be readily re-partitioned as needed for improving performance.

### BACKGROUND

Deep neural-network applications have been applied to solve various business, science and engineering problems, such as image and speech recognition, business decision making, manufacturing, and healthcare. With rapid development of Internet of things (IoTs) and edge and cloud computing, there is an increasing number of deep learning applications. A neural network is deployed to run “inference,” i.e., it is utilized to classify, recognize, and process new inputs after the neural network is trained, and is deployed in an Edge-Cloud environment, for example, speech recognition, sensing, and video streaming.

Because these deep learning applications share computation resource and network bandwidth with other applications, they are exposed to significant system and performance variations. For example, because the loads of the system and interconnect bandwidth continuously change, a decision needs to be made regarding on which cloud platform in the cloud system, or which server within a cloud platform, to offload a particular deep learning task. If a deep neural network were to be partitioned across the edge and the cloud, then a decision would have to be made regarding how to partition the data flow graph of the application given the system variations.

To find a good edge-cloud partitioning solution, an approach based on the loads of the cloud systems and interconnection bandwidth may be utilized. However, because calculating all the combinations online to find a good edge-cloud partitioning solution is expensive and this approach does not support a fine-grained repartitioning while executing within a single inference or every few inferences, which requires faster decision making, it is not desirable to statically make offload and application partitioning decisions across the edge and the cloud for situations where frequent partitioning is required or desired.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example block diagram for offloading a deep learning task.

FIG. 2 illustrates another example block diagram for offloading a deep learning task.

FIG. 3 illustrates an example block diagram for partitioning a deep learning task.

FIG. 4 illustrates an example process for determining an edge-cloud partitioning solution.

FIG. 5 illustrates an example data flow graph having a partition point.

FIG. 6 illustrates an example database of stored partition point solutions.

FIG. 7 illustrates an example partition range of the data flow graph of FIG. 5.

FIG. 8 is an example lookup table that include the edge device limitations discussed with reference to FIG. 7.

FIG. 9 illustrates an example system 900 for implementing the processes and methods described above for improving the deep learning inference performance by partitioning the deep learning inference.

### DETAILED DESCRIPTION

Systems and methods discussed herein are directed to improving deep learning inference performance, and more specifically to improving the deep learning inference performance by partitioning the deep learning inference based on system fluctuation and available resources.

To allow a quick decision on repartitioning, an offline profiling may be first performed and representative combinations, such as different servers, edges, interconnect load levels, and their associated partition points may then be precomputed allowing for quick lookup table deployment. Because a trained model is once deployed, it may be reused for multiple days/weeks before a new updated model becomes available, an offline analysis may be performed only once per-trained model and may be reused for inferences before the new updated model becomes available.

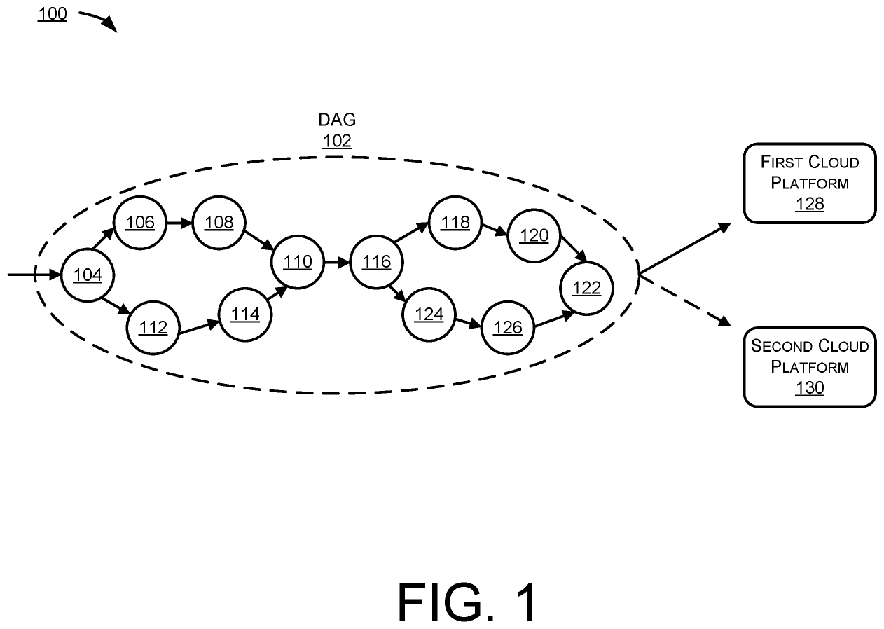

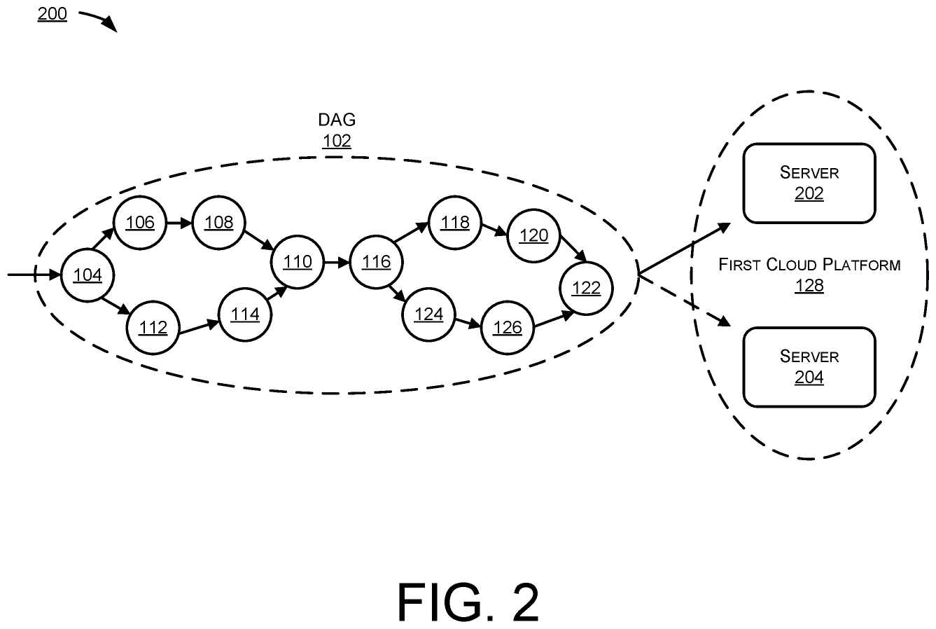

FIGS. 1 and 2 illustrate example block diagrams 100 and 200 for offloading a deep learning task.

The deep learning task may be represented by a directed acyclic graph (DAG) 102 comprising a plurality of nodes. For this example, 12 nodes, from 104 to 126 are shown to represent the DAG 102. A decision to offload the DAG 102 to a first cloud platform 128 or a second cloud platform 130 may be made based on the loads and interconnect bandwidth of the system. Alternatively, as illustrated in FIG. 2, a decision to offload the DAG 102 to a server 202 or a server 204 within the same cloud platform, such as the first cloud platform 128, may be made based on the loads and interconnect bandwidth of the system.

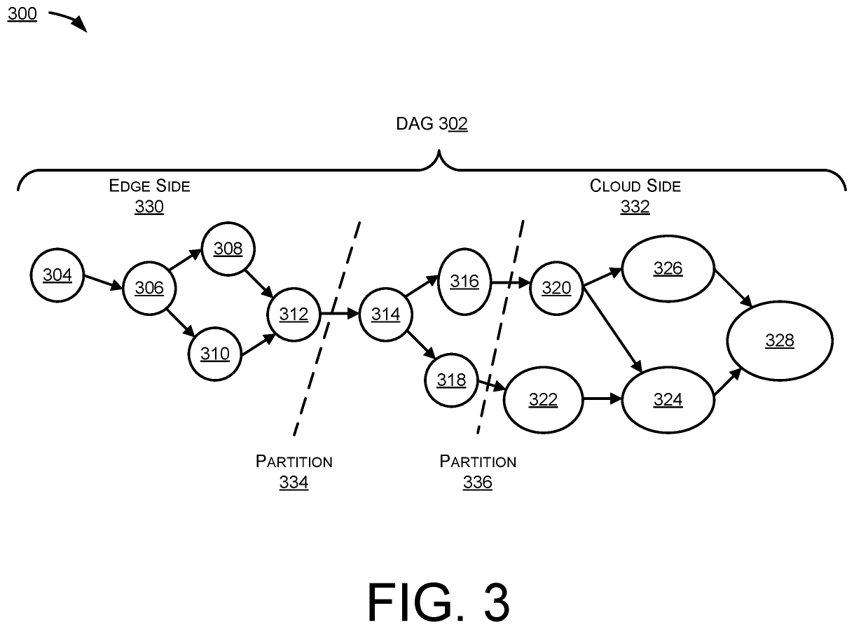

FIG. 3 illustrates an example block diagram 300 for partitioning a deep neural network.

The deep neural network may be represented by a data flow graph, such as a DAG 302 comprising a plurality of nodes. For this example, 13 nodes, 304 to 328 are shown to represent the DAG 302. The deep neural network, i.e., the DAG 302, may be partitioned to an edge side 330 and a cloud side 332 at a partition point. A decision may be made on how to partition the DAG 302 of a particular application based on the system variations. In this example, two possible partitioning planes based on the system variations are shown as partitions 334 and 336.

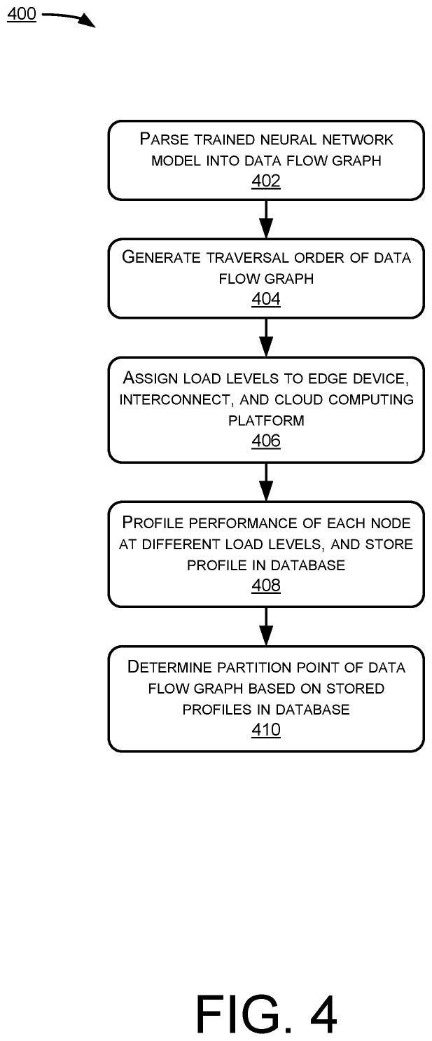

FIG. 4 illustrates an example process 400 for determining an edge-cloud partitioning solution.

The system may include an edge device, an interconnect connecting the edge device and a cloud computing platform, and the cloud computing platform, and at block 402, a trained neural network model, such as a frozen model file, of a neural network, may be parsed into a data flow graph. The neural network may be a deep neural network that is associated with the edge device, the interconnect, and the cloud computing platform. The data flow graph may be a directed acyclic graph and may comprise a plurality of nodes. Each of the plurality of nodes may represent a corresponding tensor and an associated operation with the corresponding tensor, such as convolution, matrix multiply, rectified linear unit (ReLU), and the like. Each of the plurality of nodes may also include one or more edges. An edge of a node may represent dependency of the node to one or more adjacent nodes of the node. For example, for a given node, it may start execution only after the nodes of its incoming edges finish execution. During the parsing, shape information, such as dimensions, of the tensor in each node may also be collected for calculating a data transfer overhead over an associated interconnect.

At block 404, a traversal order of the data flow graph may be generated, where the generated traversal order of the data flow graph may be one of a plurality of possible traversal orders of the data flow graph.

At block 406, various load levels may be assigned to each major component in the deep neural network, i.e., the edge device, the interconnect, and the cloud platform. For example, M, N, K load levels may be assigned to the edge device, the interconnect, and the cloud computing platform, respectively. For the cloud platform, there may be K total load levels. Level 1 may indicate that a neural network application only receives 1/K computation resources (or slowed down by a factor of K). The remaining (K−1)/K portion of the resources may be assigned to other co-scheduled applications and/or competing resources, or the neural network application may be switched to run on a slower server, etc. Level K may indicate that the neural network application receives full access to all the compute resources, the neural network application is able to achieve a supposed full speed in the deep neural network. For the interconnect, N levels may be assigned, which may indicate a degree of congestion or bandwidth utilization. Measuring the load levels of different components may be achieved by querying hardware performance counters as direct or indirect indicators.

At block 408, performance of at least a part of the plurality of nodes, i.e., one or more nodes, over the load level range for the edge device and the cloud computing platform is profiled, and the profile is stored in a database. This performance may be measured by varying different parameters, such as changing core counts, core and memory frequencies, co-scheduling with other workloads, etc. The database may be augmented with simple models, such as interpolation and/or regression, to estimate points that are not stored. Microbenchmarks may be utilized to test the latency of transferring data structures of different sizes at different congestion levels over the interconnect. In this example, there are M×N×K load combinations. For each load combination, one or more edges in the traversal order of the data flow graph may be identified, and latency may be calculated by placing a cut (test partition point) at one of the identified edges in the traversal order of the data flow graph. A configuration with a desired characteristic, such as a smallest latency, i.e., the configuration having the test partition point that resulted in the smallest latency or highest energy efficiency, may be selected as a solution configuration for this particular load combination, and the solution configuration for each load combination may be saved, or stored, into the database. All of the solution configurations may be stored in the database and each solution configuration may be indexed by a corresponding combination of load levels (m, n, k) in the database, or a lookup table.

At block 410, a partition point of the data flow graph may be determined based on the profiled performance of the one or more nodes of the plurality of nodes stored in the database, or the lookup table. The partition point for the data flow graph may be determined by selecting a partition configuration having a desired characteristic, such as a smallest latency or highest energy efficiency, from the lookup table and identifying the test partition point of the partition configuration as the partition point of the data flow graph. The edge device may execute instructions up to the partition point, the results from the last node from the edge device may then be passed across the interconnect to the nodes of the cloud platform side to resume executing the instructions. Because the lookup table contains the profiled performance of each of the plurality of nodes, re-partitioning of the data flow diagram, if needed or desired, may be readily accomplished by referring to the lookup table.

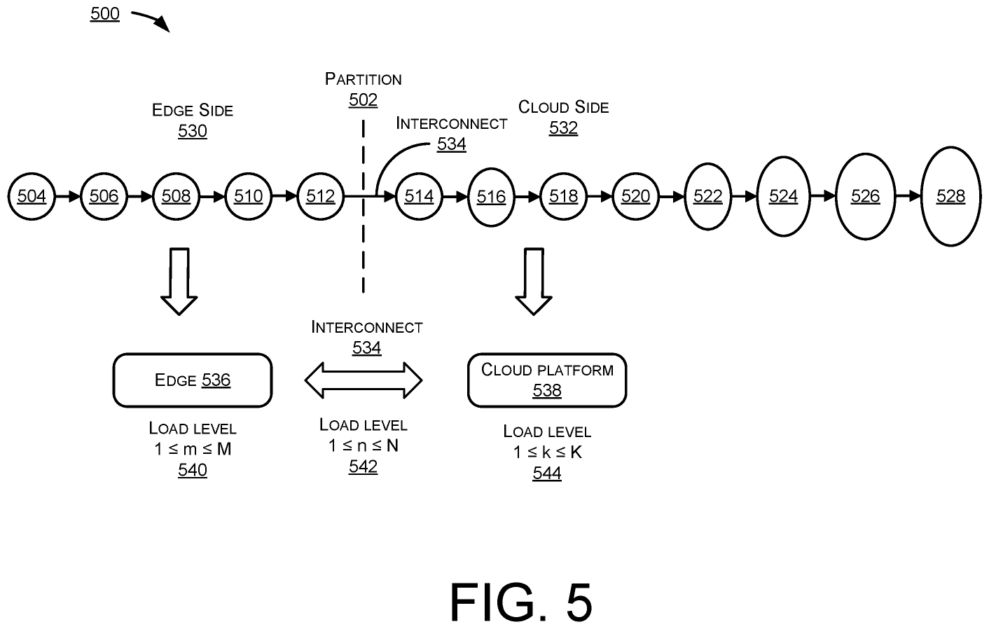

FIG. 5 illustrates an example data flow graph 500 having a partition point 502.

The data flow graph 500 may comprise a plurality of nodes, 13 nodes from 504 to 528 are shown in this example, and each node may represent a corresponding tensor and an associated operation with the corresponding tensor as described above with respect to FIG. 4. The partition point 502 may divide the data flow graph 500 into an edge side 530 and a cloud side 532. An interconnect 534 is an interconnection from the last node 512 of the edge side 530 to the first node 514 of the cloud side.

Latency of the data flow graph 500 may be calculated by assigning representative load or utilization levels to the nodes of the edge side 530 (represented as an edge 536), the interconnect 534, and the nodes of the cloud side 532 (represented as a cloud platform 538). As discussed above with reference to FIG. 4, a load level m between 1 and M (540), a load level or a bandwidth (BW) utilization level between 1 and N (542), and a load level k between 1 and K (544), may be assigned to the edge 536, the interconnect 534, and the cloud platform 538, respectively. The latency of the data flow graph 500 may then be calculated as:

$$Latency = {T}_{NODE 504 ( m )} + {T}_{NODE 506 ( m )} … + {T}_{NODE 512 ( m )} + {T}_{INTERCONNECT ( n ) ( NODES 512 AND 514 )} + {T}_{NODE 514 ( k )} + {T}_{NODE 516 ( k )} … + {T}_{NODE 528 ( k )}$$

where T indicates a time delay (latency) at an associated stage (node or interconnect) with an assigned load level (m, n, or k).

For each combination of m, n, and k, a configuration with the smallest latency may be selected as a solution for the combination and stored in the database. That is, given m, n, and k as a combination, a configuration with a partition point location resulting in the smallest latency for the combination may be selected as a solution for the combination.

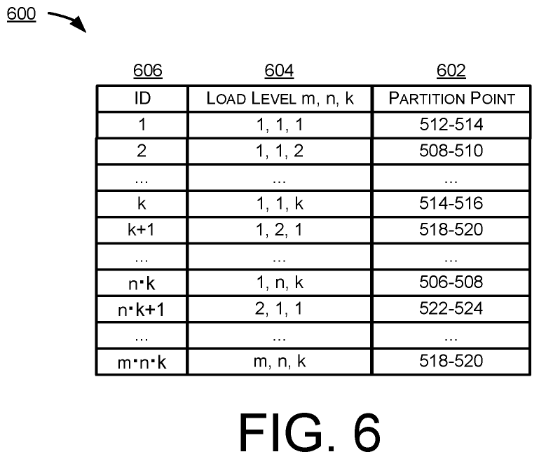

FIG. 6 illustrates an example database, or a lookup table, 600 of stored partition point solutions.

As described above with reference to FIG. 4, the solutions 602, i.e., the partition points location identified by two nodes, for all configurations may be stored in the database 600, and each solution configuration may be indexed 604 by a corresponding combination of load levels (m, n, k) in the database 600 and an identification (ID) number 606. Because the database 600 contains the profiled performance of each of the plurality of nodes, a solution, such as re-partitioning of the data flow diagram, may be readily accomplished by looking up a specific configuration in the database 600, which may also be referred as a lookup table 600.

In some scenarios, an edge device, such as an Internet of Things (IoT) device, may be constrained by its memory capacity and unable to execute a full data flow graph. With a generated traversal order of the data flow graph, a calculation may be made to determine up to which node the edge device may be able to manage the load such as computational tasks, executing instructions, data flow graph structure, and trained weights.

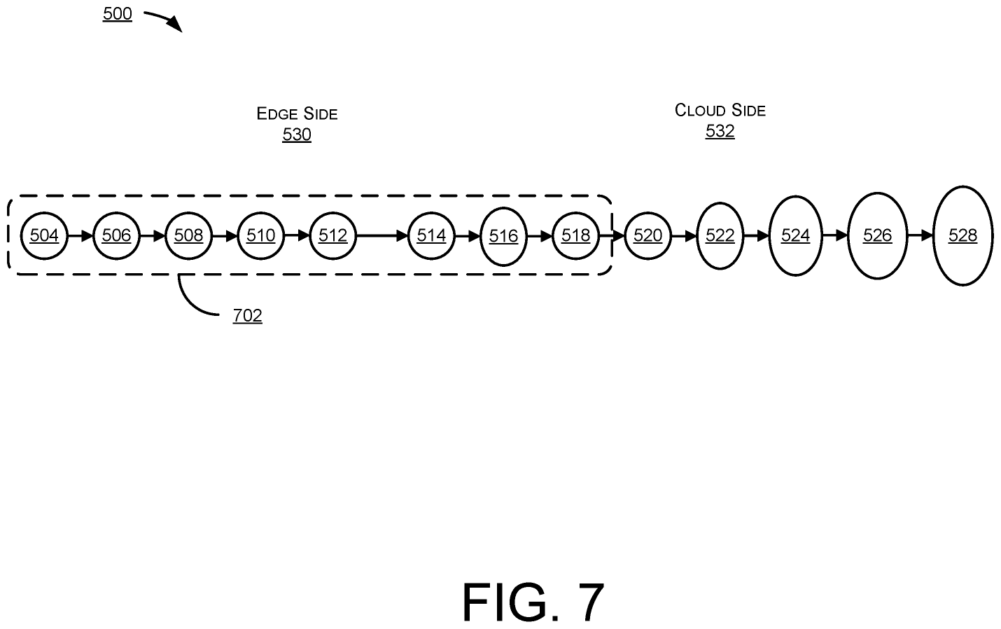

FIG. 7 illustrates an example partition range 702 of the data flow graph 500.

In this example, the calculation has determined that the edge device is able to manage the load up to the node 518 as indicated by the partition range 702. Therefore, the edge side 530 may contain only up to the node 518, and there is no need to consider partition points beyond the nodes 518 and 520 interconnection. By avoiding unnecessary computation, exchanging, or communicating, information among computing devices and components may be reduced, and computing resources (i.e., processor and memory resources for processing the information) and network resources (i.e., bandwidth for sending and receiving the information) may also be reduced. During the deployment of a system, such as a system represented by the data flow graph 500, the data flow graph structure and trained weights for the nodes that may be included in the edge device, the node 504 to 518 in this example, may be stored on the edge device. The entire data flow graph structure and trained weights may be stored in the cloud where the entire data flow graph structure may be processed. The lookup table 600 may be stored in both the edge device and the cloud.

During operation, the system, including the edge device, the cloud computing platform, may continuously monitor different counters to determine whether to repartition the data flow graph. For example, if the load levels M, N, K were to change from the values used to determine the previous partition, a decision might be made for a repartitioning. The values of the load levels M, N, K may be some experience values and depend on specific system behaviors. If the levels were too coarsely spaced, the system might lose some opportunities for performance improvement, however, if the levels were too closely spaced, the system might repartition more frequently than necessary and introduce significant overheads. To address this issue, the determination to repartition may be controlled by dynamically adjusting a threshold (T) of level changes for triggering repartitioning. During operation, a number of repartitioning over a fixed time interval may initially be compared to a predetermined number of repartitioning, and the threshold T for the time interval is set. The repartitioning may be triggered only if the value of T for a subsequent time interval exceeds the value of T for the current time interval.

The repartitioning scheme described above may be performed at the granularity of inferences, as each inference may go through the entire data flow graph. Additionally, or alternatively, the repartitioning scheme may be performed within an inference. For example, referring back to FIG. 5, when the system is at the point of executing the node 508, i.e., the nodes 504 and 506 have been completed, the repartitioning may be performed at a later portion of the data flow graph, such that the partition point 502 between the nodes 512 and 514 may be changed to a new partition point between the nodes 520 and 522 based on a load change indicated while executing the node 508.

Referring back to FIG. 6, using the lookup table 600, which are derived based on all of the node 504 to 528 in the data flow diagram 500, may generally be sufficient to improve performance. However, for a sub-traversal order of the data flow graph 500 (sub-traversal graph), from the node 510 to the node 528 for example, the best partition point may be different from the one found in the lookup table 600. To further improve performance, some representative points, the nodes 512, 518 and 522 for example, may be selected and partition points for these sub-traversals, the nodes 512-528, the nodes 518-528, and nodes 522-528, may be pre-computed. The partition point of a particular sub-traversal graph may be utilized depending on which node the system is currently executing.

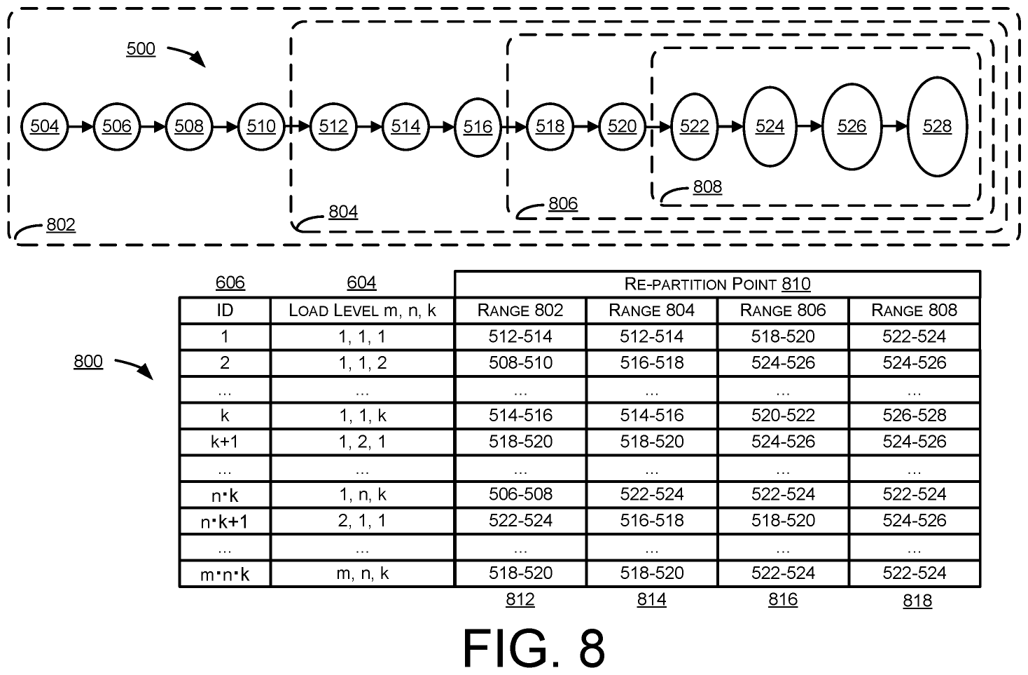

FIG. 8 is an example lookup table 800 that includes the sub-traversal graph consideration.

Compared to the lookup table 600, the lookup table 800 may include additional information regarding the sub-traversal graphs. Dotted lines 802, 804, 806, and 808 indicate re-partition ranges for the data flow graph 500. The range 802 covers all nodes 504-528 indicating that the re-partitioning calculation is the same as the partition calculation performed to determine the partition points 602 shown in the lookup table 600. The range 804 covers the nodes 512-528 indicating that the re-partitioning calculation is based on the sub-traversal graph from the node 512 to the 528. Similarly, the ranges 806 and 808 cover the nodes 518-528 and 522-528, respectively, indicating that the re-partitioning calculation is based on the sub-traversal graphs from the node 518 to the 528 and from the node 522 to the node 528, respectively. The re-partition points 810 for each range 802, 804, 806, and 808 are shown under 812, 814, 816, and 818, respectively, in the lookup table 800. Because the lookup table 800 contains the profiled performance of each of the plurality of nodes, re-partitioning of the data flow diagram, if needed or desired, may be readily accomplished by referring to the lookup table 800.

The choice of the representative nodes, such as nodes 512, 518, and 522 as described above, may be made following several guidelines. For example, convolution layers are known to consume a substantial portion of the total execution time in many image recognition applications. A profiling database, such as the lookup table 800 may be useful in determining the most time-consuming convolution layers by sorting the results. Sub-traversal graphs may include these time-consuming nodes. Further, those nodes with large tensors may also be considered when selecting representative nodes because making a partition at those nodes may affect data transfer overhead, which is subject to the interconnect bandwidth affecting latency.

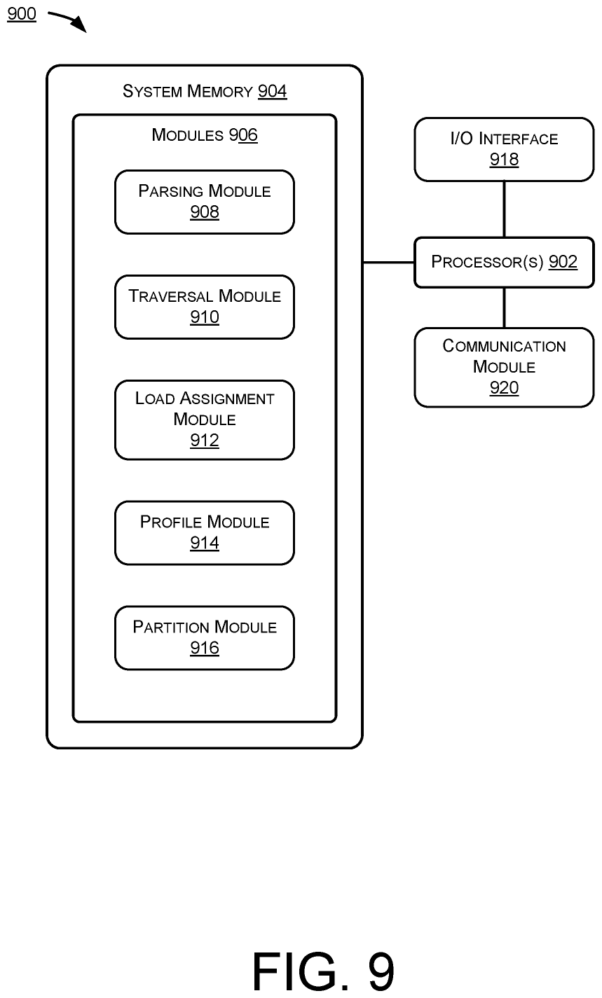

FIG. 9 illustrates an example system 900 for implementing the processes and methods described above for improving the deep learning inference performance by partitioning the deep learning inference.

The techniques and mechanisms described herein may be implemented by multiple instances of the system 900 as well as by any other computing device, system, cloud, and/or environment. The system 900 shown in FIG. 9 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 900 may include one or more processors 902 and system memory 904 communicatively coupled to the processor(s) 902. The processor(s) 902 may execute one or more modules and/or processes to cause the processor(s) 902 to perform a variety of functions. In some embodiments, the processor(s) 902 may include a central processing unit (CPU), a graphics processing unit (GPU), both CPU and GPU, or other processing units or components known in the art. Additionally, each of the processor(s) 902 may possess its own local memory, which also may store program modules, program data, and/or one or more operating systems.

Depending on the exact configuration and type of the system 900, the system memory 904 may be volatile, such as RAM, non-volatile, such as ROM, flash memory, miniature hard drive, memory card, and the like, or some combination thereof. The system memory 904 may include one or more computer-executable modules (modules) 906 that are executable by the processor(s) 902. The modules 906 may include, but are not limited to, a parsing module 908, a traversal module 910, a load assignment module 912, a profile module 914, and a partition module 916.

The parsing module 908 may be configured to parse a trained neural network model of a neural network into a data flow graph comprising a plurality of nodes, such as the data flow graph 500 with the nodes 504 to 528. As described above with reference to FIG. 4, the neural network may be a deep neural network that is associated with the edge device, the interconnect, and the cloud computing platform, and each node may represent a corresponding tensor and an associated operation with the corresponding tensor and include one or more edges. Each edge may represent dependency of the corresponding node to one or more adjacent nodes. The deep neural network may include an edge device, an interconnect connecting the edge device and a cloud computing platform, and the cloud computing platform.

The traversal module 910 may be configured to generate a traversal order of the data flow graph, which may be one of a plurality of possible traversal orders of the data flow graphs as described above with reference to FIG. 4.

The load assignment module 912 may be configured to assign a respective load level range, such as M, N, and K, to each of the edge device, the interconnect, and the cloud computing platform as described above with reference to FIGS. 4 and 5. The load assignment module 912 may be further configured to assign a respective load level, such as m, n, or k, from the respective load level range, M, N, or K, to each of the edge device, the interconnect, and the cloud computing platform to create a load combination. The load combination may be one of possible load combinations derived by combining the load level ranges M, N, and K.

The profile module 914 may be configured to profile performance of at least a part of the plurality of nodes, i.e., one or more nodes, over the respective load level ranges for the edge device and the cloud computing platform as described above with reference to FIGS. 4-6. The profile module 914 may be further configured to 1) identify one or more edges in the traversal order of the data flow graph, 2) for each edge of the identified one or more edges, calculate corresponding latency by placing a test partition point at the corresponding edge, 3) select a solution configuration having a desired characteristic, such as a smallest latency, and 4) store the solution configuration into a database, or a lookup table. The profile module 914 may be further configured to identify one or more edges in the traversal order of the data flow graph, for each load combination by 1) determining memory capacity of the edge device, 2) determining a range of nodes of the plurality of nodes that the edge device is able to execute based on the memory capacity, and 3) limiting the one or more edges to be identified based on the range of nodes.

The partition module 916 may be configured to determine a partition point of the data flow graph based on the profiled performance of the one or more nodes of the plurality of nodes as described above with reference to FIGS. 4-6. The partition module 916 may be further configured to 1) select a partition configuration having a desired characteristic, such as a smallest latency, from the stored solution configurations in the lookup table, and 2) identify the test partition point of the partition configuration as the partition point of the data flow graph.

The system 900 may additionally include an input/output (I/O) interface 918 communicatively coupled to the processor(s) 902 for exchanging data associated with operations of the system 900. The system 900 may also include a communication module 920 allowing the system 900 to communicate with other devices (not shown) over a network (not shown). The network may include the Internet, wired media such as a wired network or direct-wired connections, and wireless media such as acoustic, radio frequency (RF), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (RAM)) and/or non-volatile memory (such as read-only memory (ROM), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media that, when executed by one or more processors, may perform operations described above with reference to FIGS. 4-9. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

### Example Clauses

A. A method comprising: parsing a trained neural network model of a neural network into a data flow graph comprising a plurality of nodes, the neural network associated with an edge device, an interconnect connecting the edge device and a cloud computing platform, and the cloud computing platform; generating a traversal order of the data flow graph; assigning a respective load level range to each of the edge device and the cloud computing platform; profiling performance of at least a part of the plurality of nodes over the respective load level range for the edge device and the cloud computing platform; and determining a partition point of the data flow graph based on the profiled performance of the at least part of the plurality of nodes.

B. The method as paragraph A recites, wherein each of the plurality of nodes represents a corresponding tensor and an associated operation with the corresponding tensor.

C. The method as paragraph B recites, wherein each of the plurality of nodes further includes one or more edges, each of the one or more edges of a corresponding node representing dependency of the corresponding node to one or more adjacent nodes of the corresponding node.

D. The method as paragraph C recites, wherein assigning the respective load level range to each of the edge device and the cloud computing platform includes: assigning a respective load level from the respective load level range to each of the edge device and the cloud computing platform to create a load combination, the load combination being one of load combinations derived by combining the respective load level ranges.

E. The method as paragraph D recites, wherein profiling the performance of each of the plurality of nodes at different load levels for the edge device and the cloud computing platform includes, for each load combination: identifying one or more edges in the traversal order of the data flow graph; for each edge of the identified one or more edges, calculating corresponding latency by placing a test partition point at the corresponding edge; selecting a solution configuration having a desired characteristic; and storing the solution configuration into a lookup table.

F. The method as paragraph E recites, wherein identifying the one or more edges in the traversal order of the data flow graph includes: determining memory capacity of the edge device; determining a range of nodes of the plurality of nodes that the edge device is able to execute based on the memory capacity; and limiting the one or more edges to be identified based on the range of nodes.

G. The method as paragraph E recites, wherein determining the partition point of the data flow graph based on the profiled performance of the at least part of the plurality of nodes includes: referring to the lookup table; selecting a partition configuration having the desired characteristic from the lookup table; and identifying the test partition point of the partition configuration as the partition point of the data flow graph.

H. The method as paragraph A recites, wherein the generated traversal order of the data flow graph is one of a plurality of possible traversal orders of the data flow graphs.

I. A system comprising: one or more processors; and memory communicatively coupled to the one or more processors, the memory storing computer-executable modules executable by the one or more processors, that when executed, perform associated operations, the computer-executable modules including: a parsing module configured to parse a trained neural network model of a neural network into a data flow graph comprising a plurality of nodes, the neural network associated with an edge device, an interconnect connecting the edge device and a cloud computing platform, and the cloud computing platform; a traversal module configured to generate a traversal order of the data flow graph, the generated traversal order of the data flow graph being one of a plurality of possible traversal orders of the data flow graphs; a load assignment module configured to assign a respective load level range to each of the edge device and the cloud computing platform; a profile module configured to profile performance of at least a part of the plurality of nodes over the respective load level ranges for the edge device and the cloud computing platform; and a partition module configured to determine a partition point of the data flow graph based on the profiled performance of the at least part of the plurality of nodes.

J. The system as paragraph I recites, wherein each of the plurality of nodes represents a corresponding tensor and an associated operation with the corresponding tensor and includes one or more edges, each of the one or more edges of a corresponding node representing dependency of the corresponding node to one or more adjacent nodes of the corresponding node.

K. The system as paragraph J recites, wherein the load assignment module is further configured to assign a respective load level from the respective load level range to each of the edge device and the cloud computing platform to create a load combination, the load combination being one of possible load combinations derived by combining the respective load level ranges.

L. The system as paragraph K recites, wherein the profile module is further configured to, for each load combination: identify one or more edges in the traversal order of the data flow graph; for each edge of the identified one or more edges, calculate corresponding latency by placing a test partition point at the corresponding edge; select a solution configuration having a desired characteristic; and store the solution configuration into a lookup table.

M. The system as paragraph L recites, wherein the profile module is further configured to identify one or more edges in the traversal order of the data flow graph, for each load combination by: determining memory capacity of the edge device; determining a range of nodes of the plurality of nodes that the edge device is able to execute based on the memory capacity; and limiting the one or more edges to be identified based on the range of nodes.

N. The system as paragraph L recites, wherein the partition module is further configured to: refer to the lookup table; select a partition configuration having the desired characteristic from the lookup table; and identify the test partition point of the partition configuration as the partition point of the data flow graph.

O. A computer-readable storage medium storing computer-readable instructions executable by one or more processors, that when executed by the one or more processors, cause the one or more processors to perform operations comprising: parsing a trained neural network model of a neural network into a data flow graph comprising a plurality of nodes, the neural network associated with an edge device, an interconnect connecting the edge device and a cloud computing platform, and the cloud computing platform; generating a traversal order of the data flow graph, the generated traversal order of the data flow graph being one of a plurality of possible traversal orders of the data flow graphs; assigning a respective load level to each of the edge device and the cloud computing platform; profiling performance of at least a part of the plurality of nodes over the respective load level range for the edge device and the cloud computing platform; and determining a partition point of the data flow graph based on the profiled performance of the at least part of the plurality of nodes.

P. The computer-readable storage medium as paragraph O recites, wherein each of the plurality of nodes represents a corresponding tensor and an associated operation with the corresponding tensor, and includes one or more edges, each of the one or more edges of a corresponding node representing dependency of the corresponding node to one or more adjacent nodes of the corresponding node.

Q. The computer-readable storage medium as paragraph P recites, wherein assigning the respective load level to each of the edge device and the cloud computing platform includes: assigning a respective load level from the respective load level range to each of the edge device and the cloud computing platform to create a load combination, the load combination being one of load combinations derived by combining the respective load level ranges.

R. The computer-readable storage medium as paragraph Q recites, wherein profiling the performance of each of the plurality of nodes at different load levels for the edge device and the cloud computing platform includes, for each load combination: identifying one or more edges in the traversal order of the data flow graph; for each edge of the identified one or more edges, calculating corresponding latency by placing a test partition point at the corresponding edge; selecting a solution configuration having a desired characteristic; and storing the solution configuration into a lookup table.

S. The computer-readable storage medium as paragraph R recites, wherein identifying the one or more edges in the traversal order of the data flow graph includes: determining memory capacity of the edge device; determining a range of nodes of the plurality of nodes that the edge device is able to execute based on the memory capacity; and limiting the one or more edges to be identified based on the range of nodes.

T. The computer-readable storage medium as paragraph R recites, wherein determining the partition point of the data flow graph based on the profiled performance of the at least part of the plurality of nodes includes: referring to the lookup table; selecting a partition configuration having the desired characteristic; and identifying the test partition point of the partition configuration as the partition point of the data flow graph.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
parsing a trained neural network model of a neural network into a data flow graph comprising a plurality of nodes, the neural network associated with an edge device, an interconnect connecting the edge device and a cloud computing platform, and the cloud computing platform;
generating a traversal order of the data flow graph;
assigning a respective load level range to each of the edge device and the cloud computing platform;
profiling performance of at least a part of the plurality of nodes over the respective load level range for the edge device and the cloud computing platform; and
determining a partition point of the data flow graph based on the profiled performance of the at least part of the plurality of nodes.

2. The method of claim 1, wherein each of the plurality of nodes represents a corresponding tensor and an associated operation with the corresponding tensor.

3. The method of claim 2, wherein each of the plurality of nodes further includes one or more edges, each of the one or more edges of a corresponding node representing dependency of the corresponding node to one or more adjacent nodes of the corresponding node.

4. The method of claim 3, wherein assigning the respective load level range to each of the edge device and the cloud computing platform includes:
assigning a respective load level from the respective load level range to each of the edge device and the cloud computing platform to create a load combination, the load combination being one of load combinations derived by combining the respective load level ranges.

5. The method of claim 4, wherein profiling the performance of each of the plurality of nodes at different load levels for the edge device and the cloud computing platform includes, for each load combination:
identifying one or more edges in the traversal order of the data flow graph;
for each edge of the identified one or more edges, calculating corresponding latency by placing a test partition point at the corresponding edge;
selecting a solution configuration having a desired characteristic; and
storing the solution configuration into a lookup table.

6. The method of claim 5, wherein identifying the one or more edges in the traversal order of the data flow graph includes:
determining memory capacity of the edge device;
determining a range of nodes of the plurality of nodes that the edge device is able to execute based on the memory capacity; and
limiting the one or more edges to be identified based on the range of nodes.

7. The method of claim 5, wherein determining the partition point of the data flow graph based on the profiled performance of the at least part of the plurality of nodes includes:
referring to the lookup table;
selecting a partition configuration having the desired characteristic from the lookup table; and
identifying the test partition point of the partition configuration as the partition point of the data flow graph.

8. The method of claim 1, wherein the generated traversal order of the data flow graph is one of a plurality of possible traversal orders of the data flow graphs.

9. A system comprising:
one or more processors; and
memory communicatively coupled to the one or more processors, the memory storing computer-executable modules executable by the one or more processors, that when executed, perform associated operations, the computer-executable modules including:
a parsing module configured to parse a trained neural network model of a neural network into a data flow graph comprising a plurality of nodes, the neural network associated with an edge device, an interconnect connecting the edge device and a cloud computing platform, and the cloud computing platform;
a traversal module configured to generate a traversal order of the data flow graph, the generated traversal order of the data flow graph being one of a plurality of possible traversal orders of the data flow graphs;
a load assignment module configured to assign a respective load level range to each of the edge device and the cloud computing platform;
a profile module configured to profile performance of at least a part of the plurality of nodes over the respective load level ranges for the edge device and the cloud computing platform; and
a partition module configured to determine a partition point of the data flow graph based on the profiled performance of the at least part of the plurality of nodes.

10. The system of claim 9, wherein each of the plurality of nodes represents a corresponding tensor and an associated operation with the corresponding tensor and includes one or more edges, each of the one or more edges of a corresponding node representing dependency of the corresponding node to one or more adjacent nodes of the corresponding node.

11. The system of claim 10, wherein the load assignment module is further configured to assign a respective load level from the respective load level range to each of the edge device and the cloud computing platform to create a load combination, the load combination being one of possible load combinations derived by combining the respective load level ranges.

12. The system of claim 11, wherein the profile module is further configured to, for each load combination:
identify one or more edges in the traversal order of the data flow graph;
for each edge of the identified one or more edges, calculate corresponding latency by placing a test partition point at the corresponding edge;
select a solution configuration having a desired characteristic; and
store the solution configuration into a lookup table.

13. The system of claim 12, wherein the profile module is further configured to identify one or more edges in the traversal order of the data flow graph, for each load combination by:
determining memory capacity of the edge device;
determining a range of nodes of the plurality of nodes that the edge device is able to execute based on the memory capacity; and
limiting the one or more edges to be identified based on the range of nodes.

14. The system of claim 12, wherein the partition module is further configured to:
refer to the lookup table;
select a partition configuration having the desired characteristic from the lookup table; and
identify the test partition point of the partition configuration as the partition point of the data flow graph.

15. A computer-readable storage medium storing computer-readable instructions executable by one or more processors, that when executed by the one or more processors, cause the one or more processors to perform operations comprising:
parsing a trained neural network model of a neural network into a data flow graph comprising a plurality of nodes, the neural network associated with an edge device, an interconnect connecting the edge device and a cloud computing platform, and the cloud computing platform;
generating a traversal order of the data flow graph, the generated traversal order of the data flow graph being one of a plurality of possible traversal orders of the data flow graphs;
assigning a respective load level to each of the edge device and the cloud computing platform;
profiling performance of at least a part of the plurality of nodes over the respective load level range for the edge device and the cloud computing platform; and
determining a partition point of the data flow graph based on the profiled performance of the at least part of the plurality of nodes.

16. The computer-readable storage medium of claim 15, wherein each of the plurality of nodes represents a corresponding tensor and an associated operation with the corresponding tensor, and includes one or more edges, each of the one or more edges of a corresponding node representing dependency of the corresponding node to one or more adjacent nodes of the corresponding node.

17. The computer-readable storage medium of claim 16, wherein assigning the respective load level to each of the edge device and the cloud computing platform includes:
assigning a respective load level from the respective load level range to each of the edge device and the cloud computing platform to create a load combination, the load combination being one of load combinations derived by combining the respective load level ranges.

18. The computer-readable storage medium of claim 17, wherein profiling the performance of each of the plurality of nodes at different load levels for the edge device and the cloud computing platform includes, for each load combination:
identifying one or more edges in the traversal order of the data flow graph;
for each edge of the identified one or more edges, calculating corresponding latency by placing a test partition point at the corresponding edge;
selecting a solution configuration having a desired characteristic; and
storing the solution configuration into a lookup table.

19. The computer-readable storage medium of claim 18, wherein identifying the one or more edges in the traversal order of the data flow graph includes:
determining memory capacity of the edge device;
determining a range of nodes of the plurality of nodes that the edge device is able to execute based on the memory capacity; and
limiting the one or more edges to be identified based on the range of nodes.

20. The computer-readable storage medium of claim 18, wherein determining the partition point of the data flow graph based on the profiled performance of the at least part of the plurality of nodes includes:
referring to the lookup table;
selecting a partition configuration having the desired characteristic from the lookup table; and
identifying the test partition point of the partition configuration as the partition point of the data flow graph.
